(19) United States
(12) Patent Application Publication
(10) Pub. No.: US 2008/0208716 A1
(43) Pub. Date: Aug. 28, 2008

(54) Product information system

(76) Inventors: Brian Alan Grove, San Jose, CA (US); Chris Rice, San Jose, CA (US); Suzanne Shultz, Mountain View, CA (US)

Correspondence Address: SCHWEGMAN, LUNDBERG & WOESSNER/EBAY, P.O. BOX 2938, MINNEAPOLIS, MN, 55402, US

(21) Appl. No.: 12/069,437

(22) Filed: Feb. 8, 2008

Related U.S. Application Data
(60) Provisional application No. 60/889,233, filed on Feb. 9, 2007.

(51) Int. Cl. G06Q 30/00

(52) U.S. Cl. 705/27

(57) ABSTRACT

Product information may be structured using a product hierarchy so that products may be uniquely identified. A first level of the product hierarchy may be associated with product make and model information. A second level of the product hierarchy may be associated with product year information. A third level of the product hierarchy may be associated with product generation information. The product hierarchy may also include additional levels to accommodate other product detail information.

### CROSS REFERENCE TO RELATED APPLICATIONS

This U.S. patent application claims the benefit under 35 U.S.C. § 119(e) of U.S. Provisional Patent Application Ser. No. 60/889,233 filed Feb. 9, 2007, titled “PRODUCT INFORMATION SYSTEM,” which is incorporated by reference in its entirety herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2007, eBay Inc. All Rights Reserved.

### TECHNICAL FIELD

This patent document pertains generally to data processing, and more particularly, but not by way of limitation, to product data systems and processing techniques associated with the product data systems.

### BACKGROUND

For years, product manufacturers have been trying to develop systems to structure product information so that their products can be easily identified. Unfortunately, most systems were developed for specific industries and specific products. As such, these systems cannot be adapted to other industries or products.

### BRIEF DESCRIPTION OF THE DRAWINGS

Some embodiments are illustrated by way of example and not limitation in the figures of the accompanying drawings in which:

FIG. 1 is a block diagram that illustrates an example of a product hierarchy, in accordance with some example embodiments.

FIG. 2 is a block diagram that illustrates an example of vehicle product information using the product hierarchy, in accordance with some embodiments.

FIG. 3 is a table that illustrates an example of product comparison for products structured using the product hierarchy, in accordance with some example embodiments.

FIG. 4 is a diagram that illustrates an example of a review interface for products structured using the product hierarchy, in accordance with some example embodiments.

FIG. 5 is a block diagram that illustrates examples of a first pricing interface that may be used to determine price information, in accordance with some example embodiments.

FIG. 6 is a block diagram that illustrates examples of a second pricing interface that may be used to determine price information, in accordance with some example embodiments.

FIG. 7 is a block diagram that illustrates examples of a third pricing interface that may be used to determine price information, in accordance with some example embodiments.

FIG. 8 is a block diagram that illustrates examples of error conditions that may arise when using the third pricing interface, in accordance with some example embodiments.

FIG. 9 is a diagram that illustrates a fourth pricing interface that may be used to determine price information, in accordance with some example embodiments.

FIG. 10 is a diagram that illustrates a fifth pricing interface that may be used to determine price information, in accordance with some example embodiments.

FIG. 11 is a diagram that illustrates an interface that may be used to change the year information in a generation for a product, in accordance with some example embodiments.

FIG. 12A is a network diagram that illustrates one example network that may be used, in accordance with some example embodiments.

FIG. 12B is a module diagram that illustrates possible application modules within the application server, in accordance with some example embodiments.

FIG. 13A illustrates an example of a flow diagram that may be used to suggest a product value, in accordance with some example embodiments.

FIG. 13B illustrates an example of a flow diagram that may be used to recommend a product, in accordance with some example embodiments.

FIG. 13C illustrates an example of a flow diagram that may be used to provide product information using the product hierarchy, in accordance with some example embodiments.

FIG. 14 illustrates an example computer system, in accordance with some example embodiments.

### DETAILED DESCRIPTION

For some example embodiments, methods and systems of structuring product information are disclosed. Product information may be structured using a product hierarchy so that products may be uniquely identified. A first level of the product hierarchy may be associated with product make and model information. A second level of the product hierarchy may be associated with product year information. A third level of the product hierarchy may be associated with product generation information. The product hierarchy may also include additional levels to accommodate other product detail information.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, such that “A or B” includes “A but not B.” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Introduction

Example embodiments describe methods and systems to uniquely identify products. The below example embodiments, merely by way of example, describe defining vehicle products (e.g., based upon year, make, and model) and structuring data and functionality based upon the product and product structure. It will however be appreciated that the describe methods and systems may be employed to uniquely define any type of product or entity in any industries.

### Product Hierarchy

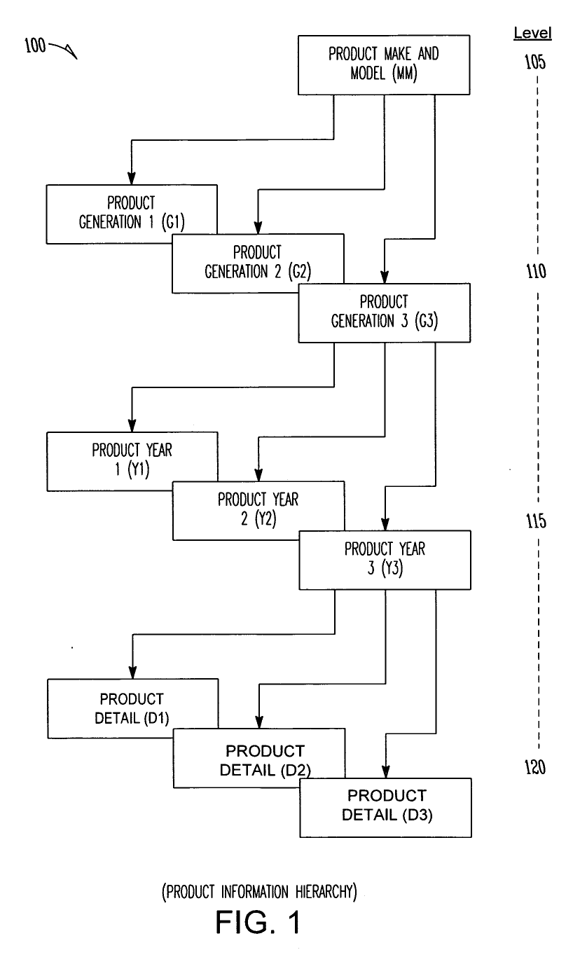

FIG. 1 is a block diagram that illustrates an example of a product hierarchy, in accordance with some example embodiments. A product hierarchy may include multiple levels and may be used to structure product information. The product hierarchy may also be used to uniquely identify products. In the current example, the product hierarchy 100 may include four (4) levels 105-120. Level 105 is at the top of the product hierarchy 100 and may include the product make and model (MM) information. The level 105 may also be referred to as a MM level.

Level 110 is at a next level from the level 105 (the MM level) and may include product generation (G) information. There may be one or more generations (e.g., G1, G2 and G3) at the level 110. The level 110 may also be referred to as a G level and may be considered a child level of the level 105. The product G information may include a range of several years. The product G information may be used when a manufacturer offers a product with the same product MM information over a period of several years. There may be some changes to the product year to year but the product MM information may remain the same. The number of generations and the number of years within a generation may vary from product to product and possibly from generation to generation.

Level 115 is at a next level from the level 110 (G level) and may include product year (Y) information. There may be one or more years (e.g., Y1, Y2 and Y3) at the level 115. The level 115 may also be referred to as a Y level and may be considered a child level of the level 110. The product year information may refer to the year (e.g., 2007) that the product is associated with. It is possible that, in some situations, a product may not be associated with any product generation information. In these situations, the product hierarchy may include only the product MM information and the product year information.

Level 120 is at a next level from the level 115 (Y level) and may include product detail (D) information. There may be one or more product detail information (e.g., D1, D2 and D3) at the level 120. The level 120 may also be referred to as a D level and may be considered a child level of the level 115. The product detail information may include specific features that may not be already identified by any of the information associated with the levels 105-115. As may be noted, each of the levels 105-120 may be related to one another.

When viewing the product hierarchy 100 as a tree diagram, the level 105 may be considered a root level, and the level 120 may be considered a leaf level. Depending on the position of a level in the product hierarchy 100, the level may be a parent level or both a parent level and a grandparent level. Similarly, a level may be a child level or both a child level and a grandchild level. For example, from a view of the level 115 as a child, the level 110 is its parent and the level 105 is its grandparent.

For some example embodiments, the YMM information may be used as a basis for identifying a unique product. Each unique product may be associated with two reference identifiers: a parent (GMM) reference identifier and a grandparent (MM) reference identifier. For some example embodiments, when searching for product information using the MM information, a search result may also include associated GMM information and YMM information.

Product Hierarchy as applied to Vehicles

When applying the product hierarchy to vehicles, the vehicle product information may be used to identify vehicles from the same manufacturer or from different manufacturers. Some examples of the vehicles include cars, trucks, etc. In these examples, the MM information may be used to identify the make and model of the vehicles such as Ford Mustang, Honda Accord, Toyota Corolla, Mercedes S500, Acura Legend, Acura TL, etc. The GMM information may be used to identify the generation along with the make and model of the vehicles such as, for example, 2000-2003 Ford Mustang, 2004-2008 Toyota Camry, etc. The YMM information may be used to identify the specific year along with the make and model of the vehicles such as, for example, 1999 Ford Mustang, 2005 Honda Accord, etc.

When using the YMM information as a basis, additional product detail information may be described. This is referred to in FIG. 1 at the level 120 (product detail information level). The product detail information may be referred to as the trim information. For some example embodiments, there may be default product detail information associated with the vehicle YMM information. In the current example, the vehicle trim information is described along with the vehicle YMM information, such as 2000 Honda Accord EX, 2000 Honda Accord LX, etc.

For some example embodiments, the G information may have a text property to store a character string associated with a year range (e.g., 2000-2004), the Y information may have a numeric property to store a number associated with a particular year (e.g., 2000, 2001, 2002, etc.), and the MM information may have a text property to store a character string associated with the make and model (e.g., Honda Accord, etc.).

Product Hierarchy with Product Review Information

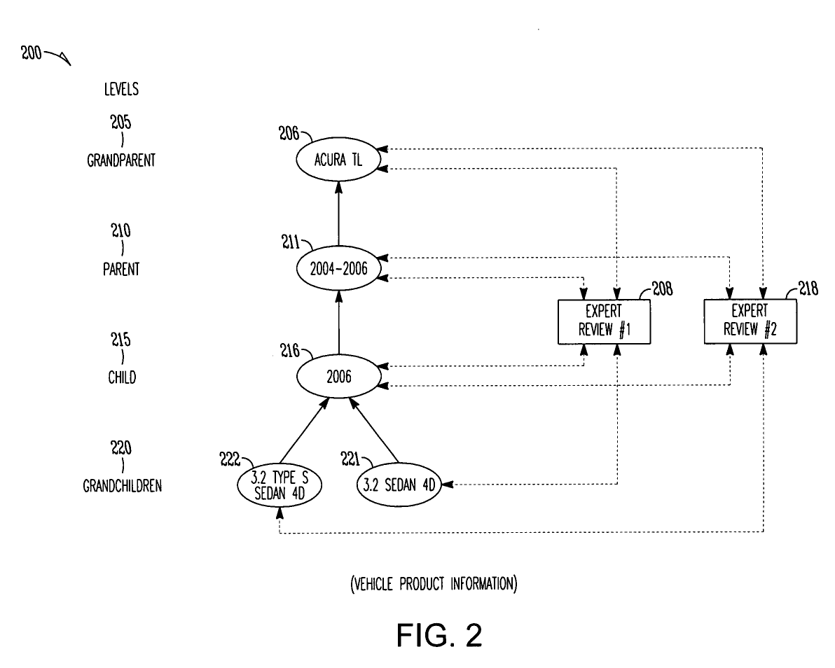

FIG. 2 is a block diagram that illustrates an example of vehicle product information using the product hierarchy, in accordance with some embodiments. Diagram 200 may be a tree diagram structured with a grandparent level 205, a parent level 210, a child level 215, and a grandchild level 220. Each of these levels may correspond to the level 105, 110, 115 or 120 illustrated in FIG. 1 in the same sequence. In the current example, the vehicle make and model is Acura TL.

For some example embodiments, each of the levels 205-220 may also be associated with review information. The review information may be about the products associated with the particular level and may be provided by a review service provider. The review service provider may collect reviews by experts in the field and may offer the reviews for the products being considered by the users. As illustrated in the example of FIG. 2, there may be two expert reviews 208 and 218 about the make and model 206 which includes the Acura TL at the grandparent level 205. There may be two expert reviews 208 and 218 about the generation 211 which includes years 2004-2006 of the Acura TL at the parent level 210. There may be two expert reviews 208 and 218 about the specific year 216 which includes the year 2006 of the Acura TL at the child level 215. Finally, there may be an expert review 208 about the specific trim 222 which includes the trim 3.2 Type S Sedan 4D of the 2006 Acura TL at the grandchild or grandchildren level 220. Similarly, there may be an expert review 218 about the specific trim 221 which includes the trim 3.2 Sedan 4D of the 2006 Acura TL at the grandchild or grandchildren level 220.

For some example embodiments, an expert review may be associated with a data type that has a numeric property. There may be a range of values (e.g., 1 to 10), with each value corresponding to a review level. Depending on the application, a small value (e.g., 1) may correspond to a high rating, and a large value (e.g., 10) may correspond to a low rating. Alternatively, the small value may correspond to a low rating. For example, when the product hierarchy is applied to vehicles, the expert review 208 and/or 218 may be provided by the Kelly Blue Book (KBB) Co., Inc. of Irvine, Calif.

For some example embodiments, the expert reviews at each of the levels of the product hierarchy may be stored and may be individually accessible. For example, a service provider may collect the product information, structure the product information using the product hierarchy, and store the expert reviews associated with the different levels of the product hierarchy. The service provider may be a company that directly or indirectly facilitates the sales of the products. The service provider may then provide interfaces to allow users to access the product information and the associated expert reviews. The interfaces may be in the forms of web pages that may be accessed using a web browser and the Internet.

For some example embodiments, the product hierarchy may be used to roll up or roll down the product information and/or the expert reviews. Rolling up may include getting more general or broader information toward the root level of the product hierarchy, while rolling down may include getting deeper or more detailed information toward the leaf level of the product hierarchy.

For some example embodiments, the expert reviews may be stored in a database using one or more database tables. The database may also store the product information structured using the product hierarchy. This may enable aggregating the expert reviews and/or the product information among different products from various hierarchical levels. For example, when performing a database query for expert reviews at the year (Y) level, a query result may include expert reviews at the detail (D) level. When performing a database query for expert reviews at the generation (G) level, a query result may include expert reviews for all the years that fall within that generation.

Product Hierarchy as applied to Product Comparison

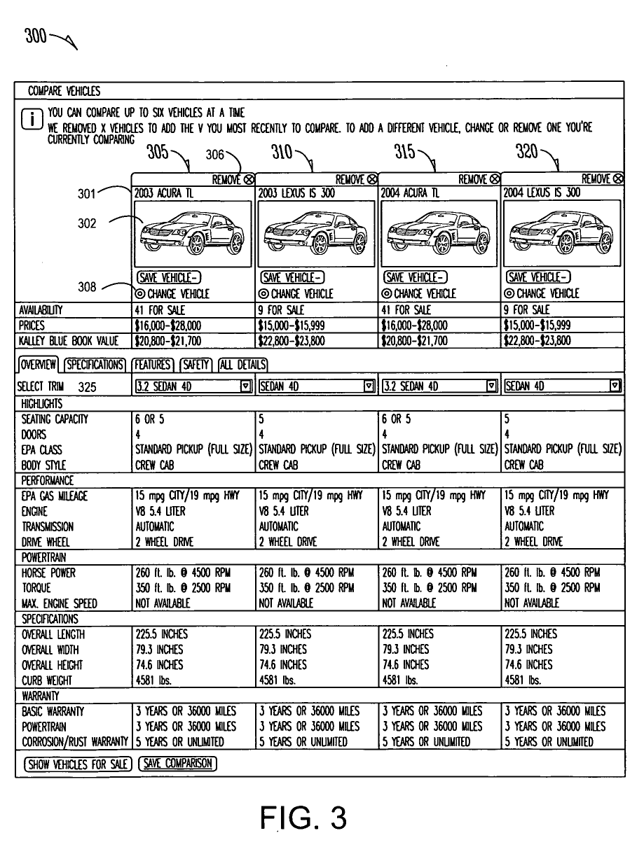

FIG. 3 is a table that illustrates an example of product comparison for products structured using the product hierarchy, in accordance with some example embodiments. When the product hierarchy is used with the vehicles, the process of comparing the vehicles may be accomplished by comparing the product levels. In the current example, comparison table 300 may include information associated with four (4) different vehicles. The comparison table 300 may be included in a web page offered by a service provider via a web site accessible using the Internet and a web browser. A user may request for and may review the comparison table 300 to compare products.

The information associated with each vehicle may be displayed in a separate column. Each column may include the YMM information and the detail or trim information associated with the particular vehicle. For example, column 305 includes YMM information 301 as 2003 Acura TL; column 310 includes information for the 2003 Lexus IS 300; column 315 includes information for the 2004 Acura TL, and column 320 includes information for the 2004 Lexus IS 300. The column 305 may also include an image 302 of the vehicle 2003 Acura TL. A vehicle may be removed from the comparison table 300 by using the remove selector 306. When a different vehicle is to be included in a column 305, the change vehicle selector 308 may be used. Although the example comparison table 300 illustrates four (4) vehicles, it may be noted that this is for illustration purpose only, and the number of vehicles that can be compared may vary.

For each vehicle in the table 300, there may be associated trim or detail information. The trim information may be changed by using the trim selector 325. A dropdown menu may be used to display different possible trims to select. In the current example, the trim being selected for the vehicle 2003 Acura TL is a 3.2 Sedan 4D, as displayed in column 305. For some example embodiments, when the trim selector 325 is used to change the trim information, the column 305 may be updated to display the new trim information. For example, the trim information may include performance information, power train information, specification information, warranty information, etc.

It may be also noted that the information included in the comparison table 300 may include information associated with the YMM level (or the year make and model information) and the information associated with the D level (or the trim information) as related to the product hierarchy. The comparison table 300 may also include other additional information that may be useful to further compare the vehicles. For example, the additional information may include KBB price information, availability information, etc.

Product Hierarchy as applied to Review/Rating

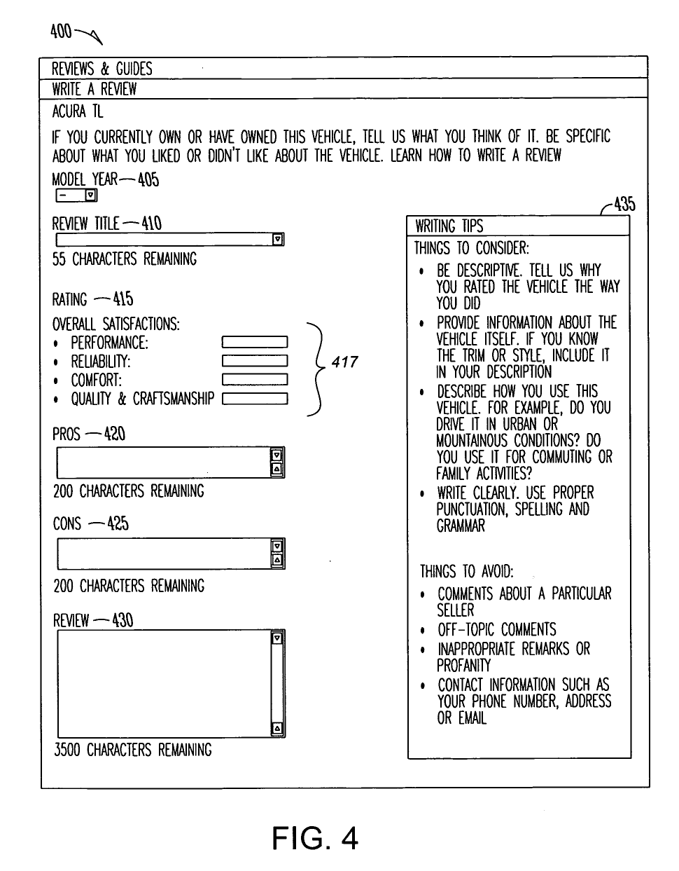

FIG. 4 is a diagram that illustrates an example of a review interface for products structured using the product hierarchy, in accordance with some example embodiments. A reviewer may request for and use review interface 400 to review a product. As discussed above, product reviews may be provided using a numeric rating system and may be specified for different levels of the product hierarchy. In the current example, the review interface 400 illustrates providing a review at the MM level for the Acura TL vehicle. If a reviewer is providing a product review for a specific year, the model year selector 405 may be used. The rating information may be provided in the rating area 415.

For some example embodiments, to choose a rating, a reviewer may interact directly with the rating bars 417. Each of the rating bars 417 may correspond to a type of rating including, for example, performance rating, reliability rating, comfort rating and quality and craftsmanship rating. For some example embodiments, one or more of the rating bars 417 may be an image, and the rating may respond dynamically to the reviewer rolling over the image. A rating may then be selected by the reviewer clicking on or selecting the image. A rating selected by the user may correspond to a numeric value. When a rating has been selected, the reviewer may be able to continue to see the other rating options by rolling over the respective images. A rolling image may return to its associated selected rating unless another rating is selected. Another alternative approach to providing the rating value is having the reviewer directly specify a numeric value for a rating.

The review interface 400 may also provide options for the product reviewer to provide comment information about the product being rated. For example, the product reviewer may provide positive textual comments using the pros input area 420. Negative textual comments may be provided using the cons input area 425. Additional comments may be provided using the review area 430. To help make the review and comments useful to other users, the review interface 400 may include review writing tips 435.

Product Hierarchy as applied to Pricing System

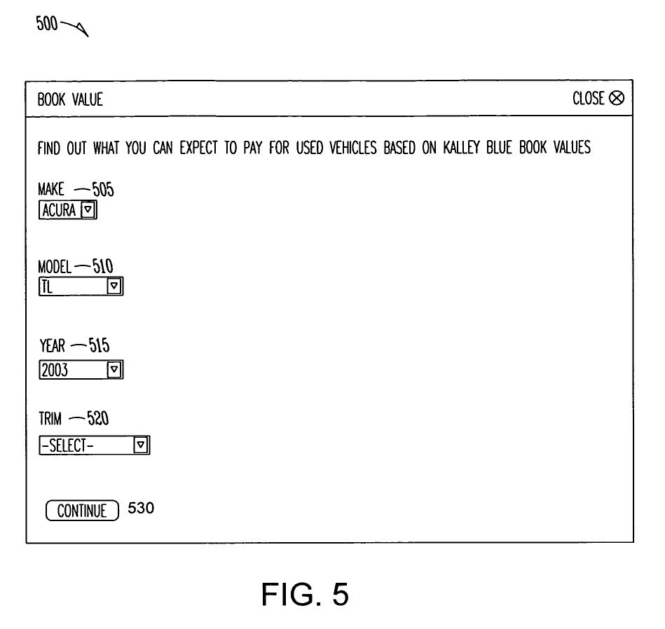

FIG. 5 is a block diagram that illustrates examples of a first pricing interface that may be used to determine price information, in accordance with some example embodiments. Pricing interface 500 may be associated with operations to identify parameters that may be used to determine a value/price of a product. A user may request for and may use the pricing interface 500 to find a suggested value for a product such, for example, as a vehicle. The pricing interface 500 may be presented to a user as a web page using a web browser and the Internet. In the current example, the vehicle may be a used vehicle. The user may provide the make and model (MM) information for the vehicle using the make field 505 and the model field 510 respectively. The user may further provide the year (Y) and the details (D) or trim information using the year field 515 and the trim field 520 respectively. The information provided by the user may be passed to a pricing system from the pricing interface 500.

Each of the fields 505-520 may be associated with an input area and may be implemented using drop down menus to enable the user to select a value to populate the appropriate input area. The pricing interface 500 may be referred to as a front end of the pricing system which a user may access. There may be a backend of the pricing system where the information from the input areas associated with the fields 505-520 may be processed. The pricing system may require all of the input areas associated with the fields 505-520 to be populated with a value. The user may have the option to modify or edit one or more input areas, and when the user is ready to pass the information to the pricing system, the continue field 530 may be selected. The pricing system may have access to a pricing database to provide the pricing information based on the vehicle information provided in the front end. For some example embodiments, the pricing database may include price information provided by a service provider that specializes in suggesting prices of used vehicles. The prices may be suggested based on the vehicle information received via the pricing interface 500 and related pricing interfaces. An example of such a pricing service provider is the KBB.

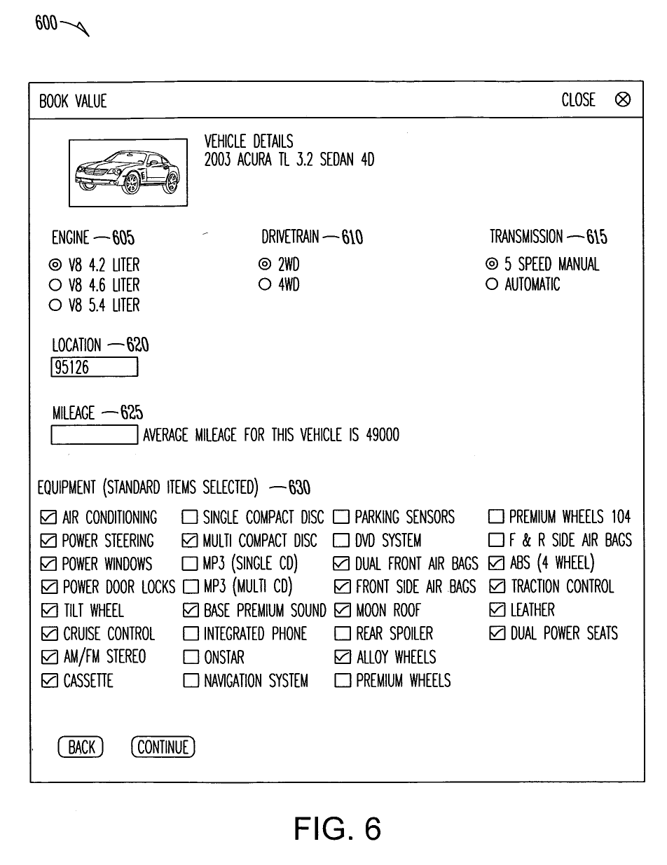

FIG. 6 is a block diagram that illustrates examples of a second pricing interface that may be used to determine price information, in accordance with some example embodiments. Pricing interface 600 may be related to the pricing interface 500. For some example embodiments, the pricing interface 600 may be presented by the pricing system after the vehicle information provided via the pricing interface 500 was received. The pricing interface 600 may include options to enable the user to specify various details or trim information about the vehicle.

The pricing interface 600 may include engine field 605, drive train field 610, transmission field 615, location field 620, mileage field 625, and equipment field 630. For some example embodiments, the pricing system may be able to access a product or vehicle information database to retrieve information about a vehicle based on its YMM and trim information. The pricing system may then use the retrieved information to determine values for one or more of the engine field 605, the drive train field 610, the transmission field 615, and the equipment field 630. For some example embodiments, these values may be edited or modified by the user. The user may be required to provide a zip code of the location of the vehicle in the location field 620 and a mileage for the vehicle in the mileage field 625.

For some example embodiments, the equipment field may include standard items pre-selected. These may be the items that are included by the manufacturer. The user may also have the option to select additional items (e.g., premium wheels, etc.) that may be added on to enable the pricing system to adjust its suggested price.

It may be noted that the engine field 605, the drive train field 610 and the transmission field 615 may be automatically determined by the pricing system based on the YMM information. This automatic determination may be based on a standard package of the vehicle. In the current example, the standard package may indicate that the engine is a V8 4.2 litter, the drive train is 2WD, and the transmission is 5 Speed Manual. For some example embodiments, the pricing interface 600 may provide the user the ability to modify these standard package settings. This may be in the forms of radio buttons, check boxes, and/or text boxes. The additional options for the user to change the standard package may be referred to as dependent options. For example, the pricing interface 600 includes multiple dependent options for each of the engine field 605, drive train field 610, and transmission field 615. Using these dependent options, a user may modify the drive train from 2WD to 4WD, the transmission from 5 Speed Manual to Automatic, etc.

The pricing interface 600 may include combinations of radio buttons, check boxes, and text boxes to enable the user to specify the dependent options and any other related information. When there is more than one option for the engine field 605, the drive train field 610, or the transmission field 615, the radio buttons may be used. If there is only one option, the text box may be used. For some example embodiments, the pricing system may include equipment or option dependency logic where an option checkbox or radio button may affect the operation of other option checkboxes and radio buttons. This is because some of the options may be mutually exclusive, and a vehicle can only have one option or the other option but not both options.

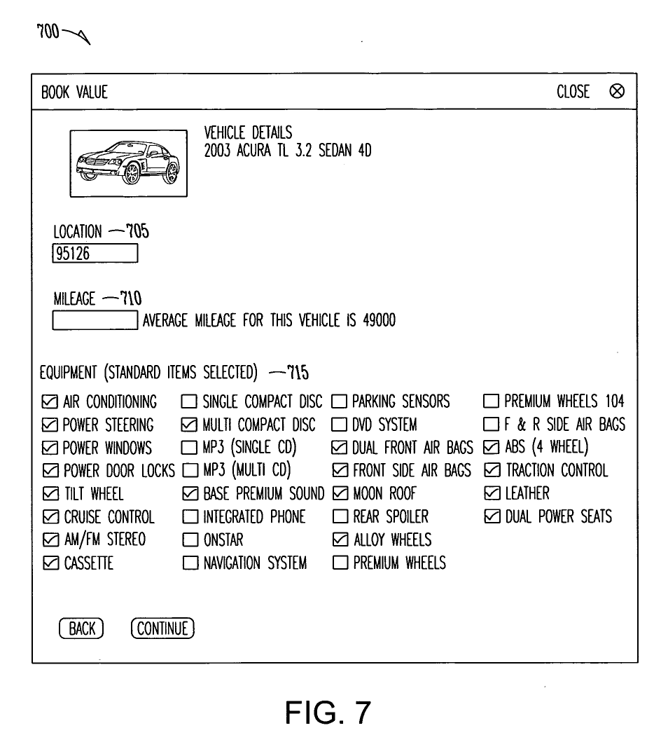

FIG. 7 is a block diagram that illustrates examples of a third pricing interface that may be used to determine price information, in accordance with some example embodiments. Pricing interface 700 may be related to one or more of the previous pricing interfaces. The pricing interface 700 may be similar to the pricing interface 600 except it does not have the information about the engine, drive train, and transmission options, and their associated dependent options. For one example embodiments, the pricing interface 700 may use the standard package options to determine the engine, drive train, and transmission information. For another example embodiment, the pricing interface 700 may use cookies to determine the appropriate engine, drive train and transmission information. The application of cookies to store and to retrieve information is known to one skilled in the art.

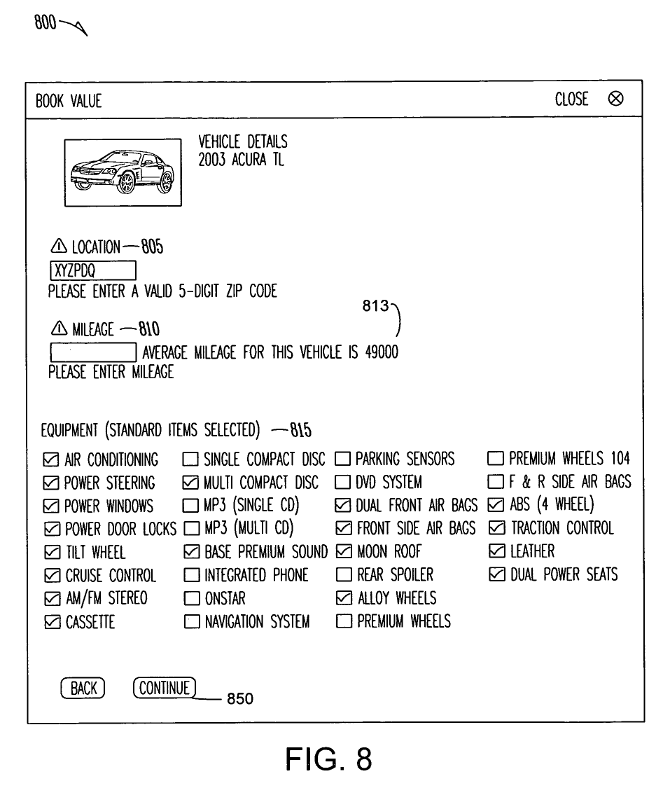

FIG. 8 is a block diagram that illustrates examples of error conditions that may arise when using the third pricing interface, in accordance with some example embodiments. Pricing interface 800 is similar to the pricing interface 700 and illustrates possible error messages that may be presented to a user when incorrect information is entered into one or more of the fields. For some example embodiments, the pricing system may try to determine the zip code information from the user cookie. When that information is not available, the pricing system may read the zip code information from the location field 805. When the pricing interface 800 is submitted by the user (e.g., by selecting the continue selector 850), the pricing system may store the zip code information in the user cookie. In the situations when the zip code information is already in the cookie, and the location field 805 is populated with different zip code information, the pricing system may use the zip code information in the location field 805. The pricing system, however, may not override the zip code information in the cookie with the zip code information in the location field 805. When the user selections the continue selector 850, an error message may be generated by the pricing system when there is no zip code information in the cookie (or there is no cookie that stores zip code information) and the location field 805 is empty. The pricing system may also detect whether the information entered into a particular field has the correct data type. For example, when a user enters a string of alphabetic characters in the location field 805, the pricing system may generate an error message because it is expecting a string of numeric characters. In the current example, the error message may be “Please enter a valid 5-digit zip code”. This is illustrated in FIG. 8 below the location field 805.

The pricing system may verify the mileage information entered into the mileage field 810. The mileage information may be required, and the mileage field 810 may be empty as a default. The pricing system may determine an average mileage for the vehicle based on the YMM information received from the user. For some example embodiments, the average mileage may be determined by using the following formula: Average mileage=(Current Year−YMM Year)*15,000. For example, if the Y information of the vehicle is 2003 and the current year is 2008, then the average mileage is (2008-2003)*15,000=75,000 miles. The average mileage information is illustrated in FIG. 8 as item 813.

The pricing system may also detect whether the information entered into the mileage field 810 has the correct data type. When the user selects the continue selector 850, an error message may be generated if there is a string of alphabetic characters in the mileage field 810 or if the mileage field 810 is empty. In the current example, the error message may be “Please enter mileage”, as illustrated in FIG. 8 below the mileage field 810. For some example embodiments, when the mileage field 810 is left blank, the average mileage determined by the pricing system may be used.

For some example embodiments, a mileage threshold may be used by the price system to adjust a suggested price. The mileage threshold may be a mileage level that may cause the vehicle to be exposed to more frequent repairs or major repairs that may affect its value. The adjustment to the price may cause the vehicle to be valued less than a value that the pricing system may typically suggest. For example, a mileage threshold may be 300,000 miles. For some example embodiments, the mileage threshold may also be used as a maximum mileage to determine the value of the vehicle. For example, when a user enters a mileage of 450,000 miles in the mileage field 810, the pricing system may determine the value of the vehicle as if it has 300,000 miles.

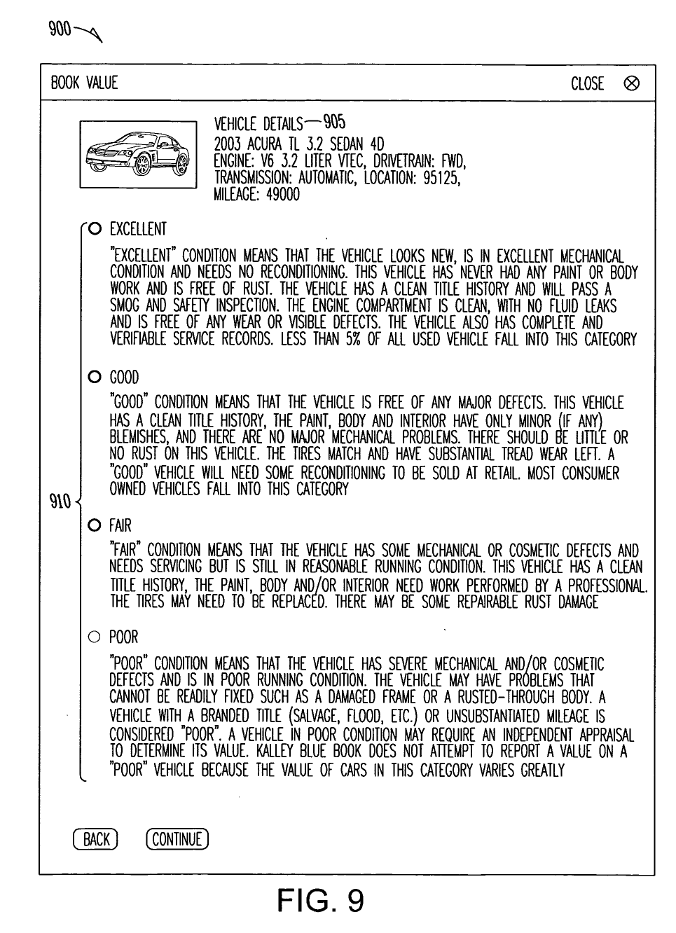

FIG. 9 is a diagram that illustrates a fourth pricing interface that may be used to determine price information, in accordance with some example embodiments. Pricing interface 900 may be related to the pricing interface 500. The pricing interface 900 may be used to specify the condition of the vehicle. For some example embodiments, there may be several condition options to be used ranging from an excellent condition down to a poor condition. In the current example, conditions 910 include “Excellent”, “Good”, “Fair”, and “Poor”. Each of the conditions 910 may be associated with a description to indicate what the condition means. Each condition may be associated with a radio button and may be selected by activating the radio button. For some example embodiment, a default condition may be pre-selected. For example, the default condition may be “Good”. It may be noted that the YMM information, the trim information, the engine information, the drive train information, the transmission information, the location information and the mileage information collected from the other pricing interfaces may be displayed as summary 905.

For some example embodiment, the pricing system may not suggest a price for a vehicle that is identified as being in a “Poor” condition. As such, the “Poor” radio button may be displayed but may not be selected. For example, the “Poor” radio button may be grayed out.

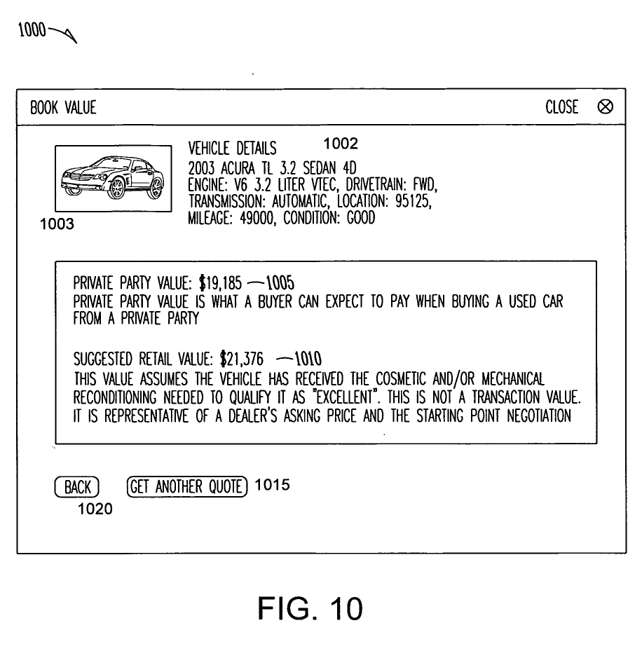

FIG. 10 is a diagram that illustrates a fifth pricing interface that may be used to determine price information, in accordance with some example embodiments. Pricing interface 1000 may be related to one or more of the previous pricing interfaces. The pricing interface 1000 may be used by the pricing system to specify the suggested value for the vehicle. For some example embodiments, the pricing system may specify a suggested price based on private party value. As illustrated in the current example, the private party value 1005 is what a buyer can expect to pay when buying a used car from a private party.

For some example embodiments, the pricing system may specify a suggested retail value. As illustrated in the current example, the suggested retail value 1010 assumes the vehicle has received cosmetic and/or mechanical reconditioning needed to qualify it as “Excellent”, and it is not a transaction value; rather, it is representative of a dealer's asking price and a starting point of negotiation. A summary of the information about the vehicle is displayed as summary 1002 which may include the YMM information, the trim information, the engine information, the drive train information, the transmission information, the location information, the mileage information, and the condition information. An image of the vehicle 1003 may also be displayed. A user using the pricing interface 1000 may have the option to get a suggested for another vehicle or for a similar vehicle but with different options by selecting the get another quote selector 1015. The back selector 1020 may also be used to modify the options of the vehicle to get an updated quote.

It may be noted that each of the pricing interfaces described with FIGS. 5-10 may be implemented as a layer with each subsequent layer relying on information provided by a previous layer. Information provided by a previous layer may be modified or edited by using a back selector from a current layer. Each layer may correspond to one or more web pages associated with a web site from a pricing suggestion service provider.

### Changing Year Information in a Generation

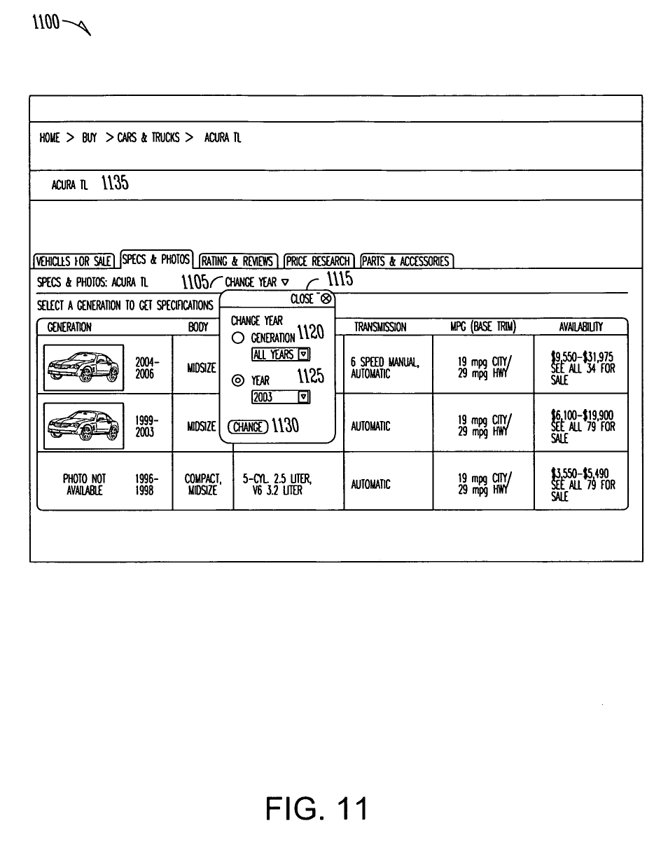

FIG. 11 is a diagram that illustrates an interface that may be used to change the year information in a generation for a product, in accordance with some example embodiments. Interface 1100 may include product information for a vehicle. For example, the interface 100 may display the make and model information 1135 as Acura TL along with the associated trim information and generation (G) information. In the current example, there are three generations including 1996-1998, 1999-2003, and 2004-2006. For some example embodiments, the generation (G) information and/or the year (Y) information may be changed. For example, a user may select the change year selector 1105 to cause a change year window 1115 to be displayed. The “Change Year” window 1115 may include generation field 1120 and year field 1125.

Each of the generation field 1120 and the year field 1125 may be associated with a radio button to activate. Each may also be associated with a dropdown menu to specify the generation or the year information, respectively. For example, a user may change the year by activating radio button of the year field 1125 and then use the associated dropdown menu to select a specific year. Similarly, a user may change the generation by activating the radio button of the generation field 1120 and then use the associated dropdown menu to select a generation. For some example embodiments, when a dropdown menu is selected, the associated radio button may be automatically selected.

For some example embodiments, the generation field 1120 may include the current generation as a default. When a product is not associated with any generation information, the generation field 1120 may not be activated and only the year field 1125 may be activated (or it may be activated as a default). The year and generation information in the dropdown menu may be retrieved from a product database.

### Product Hierarchy as Applied to Product Recommendation

When a user is viewing information about a product, recommendation about similar products may be made. For some example embodiments, the recommendation may be based the products identified by the other users as products to be watched or monitored and products identified by the other users as products to be saved. An example of a product to be watched or monitored is implemented by the auction web site of the eBay Corporation of San Jose, Calif. A user may identify an auction product (e.g., a vehicle) to be watched and may be notified by the auction web site when there are activities associated with the product or when there is a status change. A product that is identified to be saved (e.g., in a favorite list) may allow the user to review the information about the product at a later time. It may be noted that when there is a status change to a product identified to be saved, the user may not be notified. As such, there may be a higher level of interest by the user in a product that is watched than a product that is saved.

When a product is identified as to be watched or saved, there may be an indication that the user may be interested in the product, and that information may be used as a basis for recommendation. For example, when a user is reviewing vehicle information about the 2004 Audi A4, the system may recommend the 2004 BMW 3-Series, 2003 Mercedes C-Class, and the 2005 Acura TL. These recommendations may be based upon the fact than a certain number of other users who watched the 2004 Audi A4 may also watched or saved information about one or more of the other vehicles being recommended. For some example embodiments, the YMM information of the product hierarchy may be used in determining the information about the vehicle being reviewed and the information about the vehicle(s) being recommended.

For some example embodiments, the recommendations may be based on associations made between a product being viewed by a user with products watched and products saved by other users. The correlations may give higher priority to the products watched than to the products saved. The recommendations may be based on YMM information with the strongest YMM information correlations recommended to the user. For example, a user reviewing the 2003 Ford Mustang PDP may receive recommendation about the 2003 Mitsubishi Eclipse, 2003 Chevrolet Corvette, 2003 Toyota Celica, etc.

For some example embodiments, the recommendations may be based on all years within parent generation range with the strongest YMM correlations recommended to the user. For example, a user viewing the 2000-2005 Ford Mustang may receive recommendations about the 2000 Toyota Celica, 2003 Mitsubishi Eclipse, etc. For some example embodiments, the recommendations may be based upon a roll up of recommendations based on all years a particular make and model (MM) is available. In this situation, the recommendation may be made at the make and model level. For example, when a user is viewing information about a Ford Explorer, the user may receive recommendations about Jeep Cherokee, Acura MDX, Dodge Durango, etc.

### Network Diagram Example

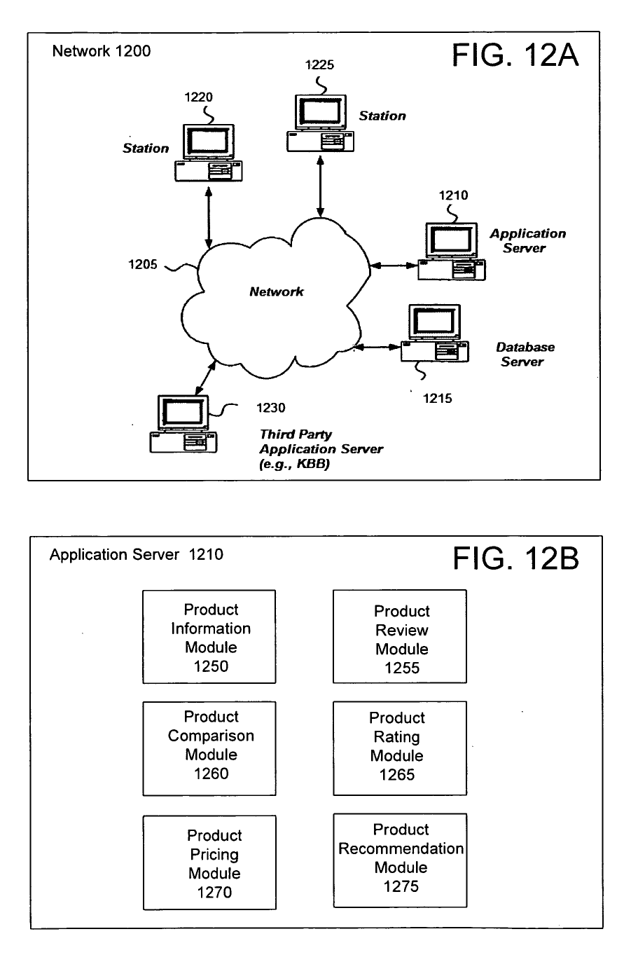

FIG. 12A is a network diagram that illustrates one example network that may be used, in accordance with some example embodiments. Diagram 1200 may include multiple stations 1220-1225 connected to network 1205 to communicate with application server 1210. The stations 1220-1225 may also be referred to as client stations. The application server 1210 may be coupled with database server 1215 to access and to update information stored in databases associated with the database server 1215. The databases may include a product information database, a product review database, etc. The application server 1210 may be associated with a web site. The network 1205 may be the Internet. A user may use the station 1220 and a web browser to connect to the network 1205 to access the web site and to review, compare and rate product information. The product information may be structured using the product hierarchy described above. The user may also access the web site to get suggested pricing for products (e.g., used vehicles) and to get recommendations for similar products. The network 1200 may also include one or more third party application servers 1230 to provide services in combination with the services provided by the application server 1210. An example of the third party application server may be a server associated with the KBB.

### Application Module Example

FIG. 12B is a module diagram that illustrates possible application modules within the application server, in accordance with some example embodiments. The application server 1210 may include a product information module 1250 which may be responsible for structuring and managing the product information according to the product hierarchy. This may include updating the product database and interacting with other application modules that may need access to the product information. The product information module may also display the product information on web pages according to the product hierarchy. The application server 1210 may include a product review module 1255 which may be responsible for associating review information with product information. The review information may be provided by a third party review service provider (e.g., KBB) and may be stored in a review database.

The application server 1210 may include a product comparison module 1260 which may be responsible for display product comparison for multiple products to enable a user to compare them. The product comparison module 1260 may include options to enable the user to change or to add products to customize the comparison, as described in the example with FIG. 3. The application server 1210 may include a product rating module 1265 to enable a user to provide rating information about a particular product, as described in the example with FIG. 4. The rating information may then be stored in a database and may be linked to the product information.

The application server 1210 may include a product pricing module 1270 which may suggest a value for a product to a user. The product pricing module may request for information from the user according to how the product is structured using the product hierarchy. An example is illustrated in FIGS. 5-10. The application server 1210 may include a product recommendation module 1275 which may be responsible for recommending to the user products that are similar to a product that the user is viewing. The similar products may be suggested based on behaviors or habits of other users who may have similar interests. As described above, the behaviors or habits may include identifying products to be watched or monitored, and saving product information in favorite list, etc.

### Flow Diagram Example

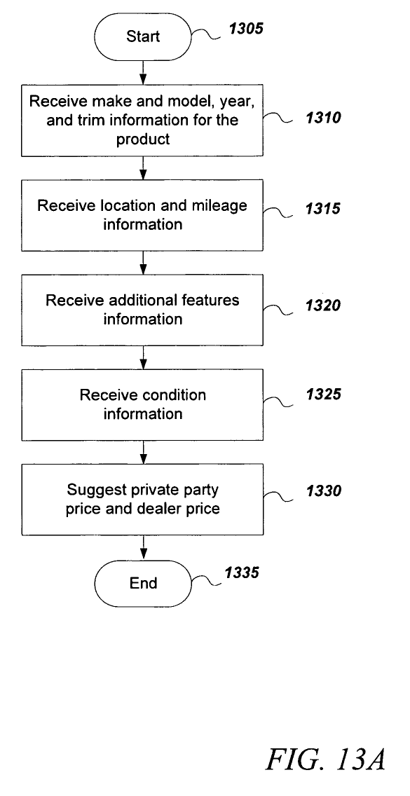

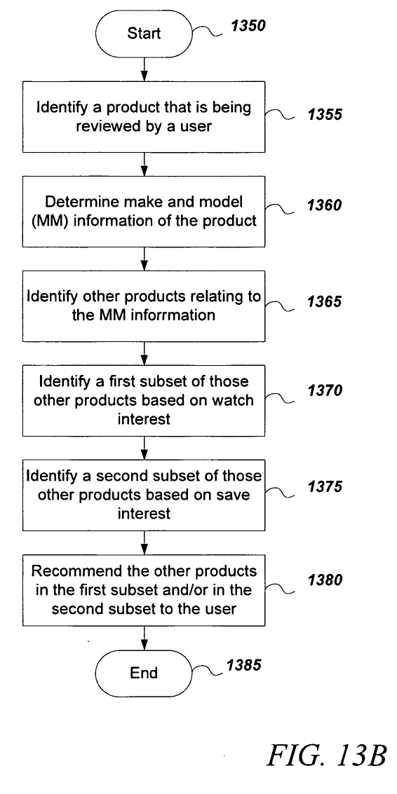

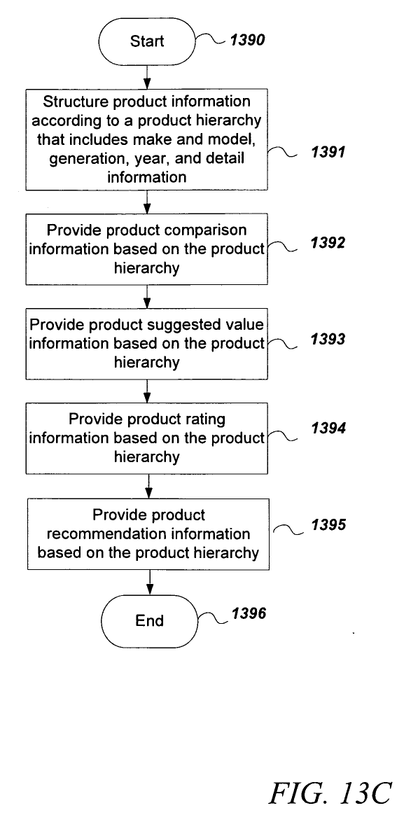

FIG. 13A illustrates an example of a flow diagram that may be used to suggest a product value, in accordance with some example embodiments. The flow diagram may correspond to the description associated with the examples illustrated in FIGS. 5-10 and may apply to suggesting a value for a used vehicle. The process may start at block 1305. At block 1310, the year, make and model, and the trim information may be received. This may be via an interface such as the pricing interface 500. At block 1315, location information and mileage information may be received. This may be via an interface such as the pricing interface 600 or 700. At block 1320, information about additional features may be received. The additional features may include features installed on the vehicle besides those provided as standard features by the manufacturer. At block 1325, condition information may be received. This may be via an interface such as the pricing interface 900. At block 1330, one or more prices may be suggested based on the information received from the user. There may be a private party price, and there may also be a dealer price. The process may end at block 1335.

FIG. 13B illustrates an example of a flow diagram that may be used to recommend a product, in accordance with some example embodiments. The flow diagram may be used to recommend products to users when there is information collected based on viewing behaviors and habits of other users. The process may start at block 1350. At block 1355, a product being viewed by a user is identified. For example, the user may be viewing a web page that displays information about a 2003 Ford Mustang. At block 1360, the make and model (MM) information of the product may be determined. In the current example, the MM is Ford Mustang. The year information (e.g., 2003) may also be determined. At block 1365, other similar products may be identified. For example, since the Ford Mustang is a sport car, it may be considered to be similar to the Mitsubishi Eclipse, the Chevrolet Corvette, or the Toyota Celica. As such, these types of vehicles may be potential candidates for recommendation. When the year information is also considered, the similar vehicles in the same year may be recommended.

At block 1370, a first subset of these potential candidate vehicles may be identified. The first subset may be identified based on a watch list or watch interest factor. As described earlier, a product may be placed in a watch list or identified as a watch interest by a user may be a product that the user prefers. For example, of the Mitsubishi Eclipse, the Chevrolet Corvette, and the Toyota Celica, there are more users showing watch interest over the Mitsubishi Eclipse and the Chevrolet Corvette than the Toyota Celica. As such, only the Mitsubishi Eclipse, the Chevrolet Corvette may be included in the subset. A watch interest threshold number may be used to determine whether a product is to be included in the first subset.

At block 1375, a second subset of these potential candidate vehicles may be identified. The second subset may be identified based on a save list or favorite list or save interest factor. As described earlier, a product may be placed in a save list or identified as a save interest by a user may be a product that the user prefers. For example, of the Mitsubishi Eclipse, the Chevrolet Corvette, and the Toyota Celica, there are more users showing save interest over the Mitsubishi Eclipse than the Chevrolet Corvette and the Toyota Celica. As such, only the Mitsubishi Eclipse may be included in the subset. A save interest threshold number may be used to determine whether a product is to be included in the second subset.

At block 1380, the products in the first subset and/or in the second subset may be recommended to the user. For some example embodiments, the products in the first subset may be ranked higher than the products in the second subset in terms of being selected for recommendations. The process may end at block 1385.

FIG. 13C illustrates an example of a flow diagram that may be used to provide product information using the product hierarchy, in accordance with some example embodiments. The flow diagram may be based on the fact that the product information is structured using the product hierarchy described above. The process may start at block 1390. At block 1391, the product information is structured using the product hierarchy that includes make and model information, generation information, year information, and detail information. At block 1392, the product information may be used to provide comparison information. At block 1933, the product information may be used to provide suggested value information. At block 1394, the product information may be used to provide rating information. At block 1395, the product information may be used to provide recommendation information. It may be noted that any one of the operations described in blocks 1392-1395 may be performed separately without requiring the operations described in the other blocks. The process may end at block 1396.

### Architecture

For some example embodiments, one implementation may be as a distributed or non-distributed software application designed under a three-tier software architecture paradigm, whereby the various modules of computer code that make up the one implementation can be categorized as belonging to one or more of these tiers. The first tier may be an interface level that is relatively free of application processing. The second tier may be a logic level that performs processing in the form of logical/mathematical manipulations (logical manipulations) of data inputted through the interface level, and communicates the results of these logical manipulations with the Interface and/or backend or storage level. Some example embodiments may include these logical manipulations relating to certain business rules or tasks that govern the application as a whole. These logical manipulations and associated business rules may used to implement the operations described herein.

The third tier or storage level may be a persistent storage medium, or, some example embodiments may include non-persistent storage medium. One or more of these tiers may be collapsed into one another, resulting in a two-tier architecture, or one-tier architecture. For example, the interface and logic levels may be consolidated, or the logic and storage level may be consolidated, as in the case of an application with an embedded database. This three-tier architecture may be implemented using one technology, or as will be discussed below, a variety of technologies. These technologies may include one or more object-oriented programming languages such as, for example, JAVA™, C++, DELPHI™, C#, or the like. Additionally, structured programming languages such as, for example, C, may also be used. Moreover, scripting languages such as, for example, Perl, Python, PHP, JAVASCRIPT™ or VBSCRIPT™ may also be used. This three-tier architecture, and the technologies through which it is implemented can be implemented in two or more computers organized in a server-client relationship, as is well known in the art, such that an interface level resides on a client computer, whereas a logic level resides on the application server (see below) and the storage level resides on a database server (see below). As will be discussed more fully below, in such a relationship these three tiers can be implemented as various software components that communicate via distributed programming protocols. Some example embodiments may include these three tiers being implemented in a peer-to-peer configuration, with centralized or decentralized file and data sharing, or some other suitable file sharing paradigm, such that all three tiers reside on one or more computers and each computer retrieves files and data from one another.

### Interface Level

For some networked example embodiments, a client-based browser application may be used, whereas other example embodiments may be implemented via a command line interface. Some example embodiments of a client based browser application may include an Application Programming Interface (API) implemented to allow one application to communicate with another. Some well-known client-based browser applications include NETSCAPE™, INTERNET EXPLORER™, MOZILLA FIREFOX™, OPERA™, or some other suitable browser application. Common to these browser applications is the ability to utilize a Hyper-Text Transfer Protocol (HTTP) or Secured Hyper-Text Transfer Protocol (HTTPS) to get, upload (e.g., PUT) or delete web pages and interpret these web pages which are written in HTML and/or XML. HTTP and HTTPS are well known in the art, as are HTML and XML. HTTP and HTTPS are used in conjunction with a Transmission Control Protocol/Internet Protocol (TCP/IP) protocol as described in the Open Systems Interconnection Reference Model (OSI) model, or the TCP protocol stack model, both of which are well known in the art. The practical purpose of the client-based browser application is to enable a user to interact with the application through the display of plain text, and/or interactive, dynamic functionality in the form of buttons, text boxes, scroll down bars or other objects, widgets contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages is a product of the use of the other technologies in combination with HTML and/or XML.

Some example embodiments may include using Java Server Page (JSP™), or Active Server Pages (ASP™ or ASP.NET™) (collectively server pages) to provide a user with dynamic web pages or content via their web browser. Additional technology may be implemented in the form of an additional program (e.g., routine) written in another programming language that is embedded into the HTML and/or XML code, allowing for web pages to become dynamic. Some of these additional technologies include, for example, embedded routines written in the Java programming language, the JAVASCRIPT™ language, or the VBSCRIPT™ programming language, or some other suitable programming language. These embedded routines are used to execute the aforementioned HTTP, and/or HTTPS requests (e.g., GET, PUT, and DELETE) for web pages. For example, a web page or server page may allow a user to make a rating file, or to get a record, or even to retrieve digital content.

Some example embodiments may include, for example, a GUI used and implemented via a Java Servlet, Applet, or VBSCRIPT™ or C# form, or some other suitable programming language. This form may reside on one or more of the devices 119 as a client application. Moreover, this form may contain objects such as text boxes, buttons, scroll-down bars, widgets, or some other suitable dynamic interface object. These objects, and the routines governing them, allow a user to retrieve, input, or delete content, just to name few of the functions. For example, a form may allow a user to make a rating file, or to get a record, or even to retrieve digital content.

### Logic Level

Some example embodiments may include the above described web pages, and/or server pages being stored on one or more remote server computers connected to the client computer via an Internet. These remote servers can be a web server and/or application server. Web servers running JSP™ can include the APACHE™/APACHE TOMCAT™ web server. Web servers running ASP™ can include a MICROSOFT WINDOW WEB SERVER 2003™ utilizing Internet Information Services (IIS). Application servers running JSP™ can include the Orion Application Server or other J2EE™ certified application servers. Application servers running ASP™ can include WINDOWS SERVER 2003™. For example, a web server may serve a web page over a network that allows a user to enter in data. This data is then passed to an application server, wherein various methods described below are applied to this data.

For some example embodiments, the logic level may be governed by a rule set written in a scripting language that controls how and when certain web pages, server pages, or pieces of content are provided to, or made accessible to, a particular user. This scripting language can be in the form of Java, Perl, Python, or some other general purpose scripting language. For example, once the logic of a JSP™ determines that a particular object (e.g., a text box) on a web page has been executed (e.g., rating record request is entered and sent), the data from this text box is inputted, and sent to a web and/or application server. It is the routine written in a scripting language that determines whether, for example, the title data is valid (e.g., that the proper title of a piece of digital content has been entered). Some example embodiments may further include a routine written in a scripting language to retrieve data from a storage, data structure, or database level. The storage level will be run by a separate database application, while, in other embodiments, a database embedded with a logic level will be implemented (e.g., a Native database).

For some example embodiments, the above described client application forms may be used to interact with a logic level. For example, a form may take in data from a user and pass it to one of the above described web and/or application servers. Once passed to one of these servers via a network connection, various methods as described below may be applied to the data.

### Storage Level

Some embodiments may include a storage level wherein tables of data are created, and data is inserted into, selected from, these tables using a Structured Query Language (SQL) or some other database-related language known in the art. These tables of data can be managed using a database application such as, for example, MYSQL™, SQLServer™, Oracle 8I™ or 10G™, or some other suitable database application. These tables are organized into a Relational-Database Schema (RDS) or Object-Relational-Database Schemas (ORDS), as is known in the art. These schemas can be normalized using certain normalization algorithms so as to avoid abnormalities such as non-additive joins and other problems. Additionally, these normalization algorithms include Boyce-Codd Normal Form or some other normalization, optimization algorithm known in the art. Some embodiments may include creating a series of database tables containing data related to digital content. These tables could be distinguished based upon the author of the rating information, the author of the digital content that is actually rated, the name of the content, or some other suitable means of distinguishing the rating information.

Various data types may be implemented including strings, integers, Character Large Objects (CLOB), Binary Large Objects (BLOB) where the actual digital content may be stored with an entry or where it is stored with the digital content store database, or some other suitable data type.

### Component Design

Some example embodiments may include the above described three tiers or levels being written as one or more software modules with each module contributing to the functionality of each level or tier. Many of these modules include the ability to generate, use and manipulate the above-described data and data sets. These modules, and associated functionality, may be used by the client, server, or peer applications. These various modules can be implemented into the system on an as-needed basis. These modules may be written in an object-oriented-computer language such that a component oriented or object-oriented programming technique can be implemented using a Visual Component Library (VCL), Component Library for Cross Platform (CLX), Java Beans (JB), Java Enterprise Beans (EJB), Component Object Model (COM), or Distributed Component Object Model (DCOM) or other suitable technique. These modules are linked to other modules via various APIs and then compiled into one complete server and/or client application. The process for using modules in the building of client and server applications is well known in the art. Further, these modules, and the tiers that they make up, are linked together via various distributed programming protocols as distributed computing modules.

### Distributed Computing Modules

Some example embodiments may include remote procedure calls being used to implement one or more of the above described levels of the three-tier architecture across a distributed programming environment. For example, a logic level resides on a first computer system that is remotely located from a second computer system containing an Interface or storage level. These first and second computer systems can be configured in a server-client, peer-to-peer or some other configuration. These various levels can be written using the above described component design principles, and can be written in the same programming language, or a different programming language. Various protocols are implemented, to enable these various levels, and components contained therein, to communicate regardless of the programming language used to write these components. For example, a module written in C++ using the Common Object Request Broker Architecture (CORBA) or Simple Object Access Protocol (SOAP) can communicate with another remote module written in JAVA™. These protocols include SOAP and CORBA or some other suitable protocol. These protocols are well-known in the art.

Information Transmission between a Server and Client

For some example embodiments, the above described components that make up the platform architecture communicate using the OSI or TCP/IP stack models for defining network protocols that facilitate the transmission of data. Applying these models, a system of data transmission between a server and client computer system can be described as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications, whereas in other embodiments another protocol known in the art is utilized. Content from an application residing at the application layer is loaded into the data load field of a TCP segment residing at the transport layer. This TCP segment also contains port information for a remote recipient application module. This TCP segment is loaded into the data field of an IP or UDP datagram residing at the network layer. Next, this IP datagram is loaded into a frame residing at the data link layer. This frame is then encoded at the physical layer and the content transmitted over a network such as an Internet, Local Area Network (LAN) or Wide Area Network (WAN). The terms Internet refers to a network of networks. Such networks may use a variety of protocols for exchange of information, such as TCP/IP, ATM, SNA, SDI, etc, and may be used within a variety of topologies or structures. This network may include a Carrier Sensing Multiple Access Network (CSMA) such an Ethernet based network. This network may include a Code Divisional Multiple Access (CDMA) network, or some other suitable network.

### Computer System

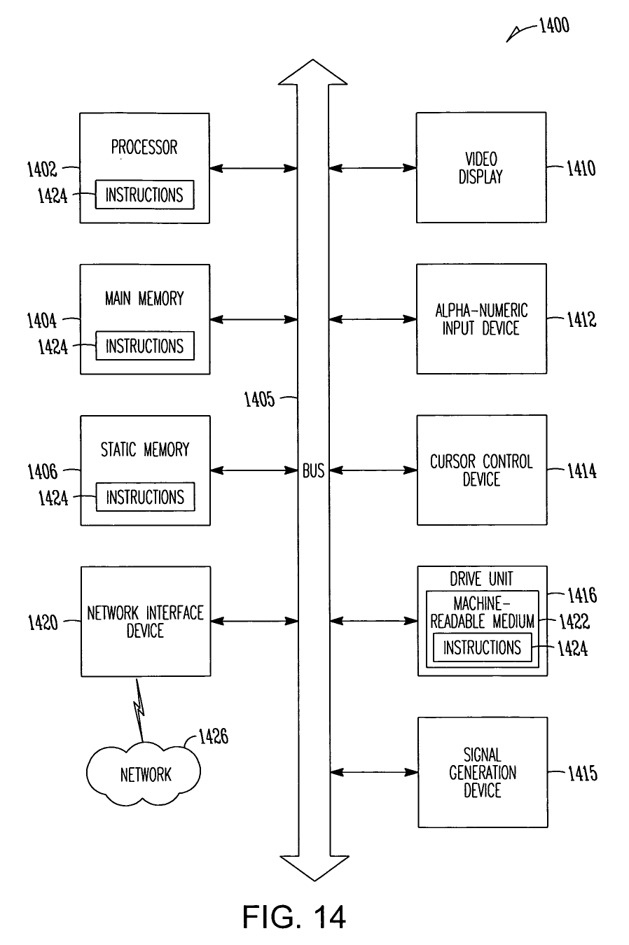

FIG. 14 illustrates an example computer system, in accordance with some example embodiments. In some embodiments, an embodiment may be implemented entirely in executable computer program instructions which are stored on a computer-readable medium or may be implemented in a combination of software and hardware, or entirely in hardware via circuits such as logic circuits.

Embodiments may include computer-readable medium for carrying or having computer-executable instructions or data structures stored thereon. For example, the instructions may be associated with the operations described in the flow diagrams of FIGS. 13A-13C. Such computer-readable medium may be any available medium which is accessible by a general-purpose or special-purpose computer system. By way of example, and not limitation, such computer-readable medium can comprise physical storage medium such as RAM, Read Only Memory (ROM), Erasable Programmable Read-Only Memory (EPROM) Compact Disk-Read Only Memory (CD-ROM), or other optical-disk storage, magnetic-disk storage or other magnetic-storage devices, or any other medium which can be used to carry or store desired program code means in the form of computer-executable instructions, computer-readable instructions, or data structures and which may be accessed by a general-purpose or special-purpose computer system. This physical storage medium may be fixed to the computer system as in the case of a magnetic drive or removable as in the case of an EEPROM device (e.g., flash memory device).

In some embodiments, when information is transferred or provided over a network or another communications connection (e.g., either hardwired, wireless, or a combination of hardwired or wireless) to a computer system, the connection is properly viewed as a transmission medium. Thus, any such connection is properly termed a transmission medium.

Computer-executable or computer-readable instructions comprise, for example, instructions and data which cause a general-purpose computer system or special-purpose computer system to perform a certain function or group of functions. The computer-executable or computer-readable instructions may be, for example, binaries, or intermediate format instructions such as assembly language, or even source code.

In this description, and in the following claims, a computer system is defined as one or more software modules, one or more hardware modules, or combinations thereof, that work together to perform operations on electronic data. For example, the definition of computer system includes the hardware modules of a personal computer, as well as software modules, such as the operating system of the personal computer. The physical layout of the modules is not important. A computer system may include one or more computers coupled via a network. Likewise, a computer system may include a single physical device (e.g., a mobile phone or PDA) where internal modules (e.g., a processor and memory) work together to perform operations on electronic data.

Some embodiments may be practiced in network computing environments with many types of computer system configurations, including hubs, routers, wireless Access Points (APs), wireless stations, personal computers, laptop computers, hand-held devices, multi-processor systems, microprocessor-based or programmable consumer electronics, network Personal Computers (PCs,) minicomputers, mainframe computers, mobile telephones, PDAs, pagers, and the like. One embodiment can also be practiced in distributed system environments where local and remote computer systems, which are linked (e.g., either by hardwired, wireless, or a combination of hardwired and wireless connections) through a network, both perform tasks. In a distributed system environment, program modules may be located in both local and remote memory-storage devices (see below).

The below figure shows a diagrammatic representation of a machine in the example form of a computer system 1400 which executes a set of instructions for causing the machine to perform any one or more of the methodologies discussed herein.

In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1400 includes a processor 1402 (e.g., a Central Processing Unit (CPU), a Graphics Processing Unit (GPU) or both), a main memory 1404 and a static memory 1406, which communicate with each other via a bus 1408. The computer system 1400 may further include a video display unit 1410 (e.g., a Liquid Crystal Display (LCD) or a Cathode Ray Tube (CRT)). The computer system 1400 also includes an alphanumeric input device 1412 (e.g., a keyboard), a User Interface (UI) cursor controller 1414 (e.g., a mouse), a disk drive unit 1416, a signal generation device 1415 (e.g., a speaker) and a network interface device (e.g., a transmitter) 1420.

The disk drive unit 1416 includes a machine-readable medium 1422 on which is stored one or more sets of instructions 1424 and data structures (e.g., software) embodying or utilized by any one or more of the methodologies or functions described herein. The software may also reside, completely or at least partially, within the main memory 1404 and/or within the processor 1402 during execution thereof by the computer system 1400, the main memory 1404 and the processor 1402 also constituting machine-readable media.

The instructions 1424 may further be transmitted or received over a network 1426 via the network interface device 1420 utilizing any one of a number of well-known transfer protocols (e.g., HTTP, SIP).

While the removable physical storage medium is shown in an example embodiment to be a single medium, the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies described herein. The term “machine-readable medium” shall accordingly be taken to include, but not be limited to, solid-state memories, optical and magnetic medium.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The above description is intended to be illustrative, and not restrictive. For example, the above-described embodiments (or one or more aspects thereof) may be used in combination with each other. Other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A computer implemented method comprising:
structuring product information according to a product hierarchy, the product information including product make information, product model information, product generation information, product year information and product detail information, wherein a combination of the product make information and the product model information is associated with one or more product generation information, and wherein each product generation information is associated with one or more product year information, and wherein each product year information is associated with one or more product detail information; and
displaying the product information according to a request by a user and according to the product hierarchy, wherein the request is associated with at least one of product comparison, product suggested value, and product rating.

2. The computer implemented method of claim 1, wherein the product hierarchy includes multiple levels, wherein the product make information and the product model information are associated with a root level, and wherein the product detail information is associated with a leaf level.

3. The computer implemented method of claim 2, wherein the product information is displayed according to product information associated with each level of the product hierarchy.

4. The computer implemented method of claim 2, wherein product review information is associated with the product information according to the product hierarchy at a level-by-level basis.

5. The computer implemented method of claim 2, wherein a combination of the product year information, the product make information, and the product model information is used as a basis to identify a product and to provide services to the user based on the identified product.

6. The computer implemented method of claim 2, wherein a combination of the product year information, the product make information, and the product model information is used as a basis to identify a product being viewed by the user and to recommend one or more similar products to the user.

7. The computer implemented method of claim 6, wherein the one or more similar products recommended to the user are identified based at least on one of watch interest and save interest of other users.

8. The computer implemented method of claim 2, wherein a combination of the product year information, the product make information, and the product model information is used as a basis to provide the product comparison, the product suggested value, and the product rating.

9. A machine-readable medium comprising instructions, which when implemented by one or more machines cause the one or more machines to perform the operations described in the method claim 1.

10. A computer implemented method comprising:
identifying information associated with a product that a user is viewing; and recommending to the user a first set of products similar to the product that the user is viewing, wherein the first set of products includes products identified by other users as products to be watched.

11. The computer implemented method of claim 10, where a user associated with a product to be watched is notified when status of the product to be watched changes.

12. The computer implemented method of claim 11, further comprising:
recommending to the user a second set of products similar to the product that the user is viewing, wherein the second set of products includes products identified by the other users as products to be saved.

13. The computer implemented method of claim 12, wherein when a product is identified as a product to be saved, information associated with that product is saved for subsequent access.

14. The computer implemented method of claim 12, wherein the second set of products is given a lower priority than the first set of product when both the first set of products and the second set of products are recommended to the user.

15. The computer implemented method of claim 14, wherein the product that the user is viewing is associated with make information, model information and year information, and wherein the products in the first set of products and in the second set of products have similar make information, model information and year information.

16. A machine-readable medium comprising instructions, which when implemented by one or more machines cause the one or more machines to perform the operations described in the method claim 10.

17. A computer system comprising:
an application server configured to provide services related to product information; and
a database server coupled with the application server and include databases to store the product information, wherein the product information is structured using multiple hierarchical levels with a first level including product make information and product model information, a second level including product generation information, a third level including product year information and a fourth level including product detail information, and wherein the database server is to further store product review information associated with each of the first level, the second level, the third level and the fourth level.

18. The computer system of claim 17, wherein a combination of the product make information and the product model information at the first level is associated with one or more product generation information at the second level, and wherein each product generation information at the second level is associated with one or more product year information at the third level, and wherein each product year information at the third level is associated with one or more product detail information at the fourth level.

19. The computer system of claim 17, further comprising:
a third party application server coupled to the application server to provide suggested pricing information associated with the product information stored in the databases.

20. The computer system of claim 19, wherein the application server includes application modules that use the product information structured in multiple hierarchical levels to provide product comparison services, product suggested value services, product rating services, and product recommendation services.

21. The computer system of claim 20, wherein the application module that provides the product recommendation services uses habit information of other users in deriving at products to be recommended.
